(19) United States
(12) Patent Application Publication
(10) Pub. No.: US 2016/0014578 A1
(43) Pub. Date: Jan. 14, 2016

(54) Multiple Active Voice Calls on a Multi-SIM Multi-Active Device

(71) Applicant: QUALCOMM Incorporated, San Diego, CA (US)

(72) Inventors: Pavan Kumar Kadiyala, Hyderabad (IN); Ramlal Karra, Hyderabad (IN)

(21) Appl. No.: 14/330,236

(22) Filed: Jul. 14, 2014

(51) Int. Cl. H04W 4/16; H04M 1/725; H04W 4/06

(52) U.S. Cl. CPC H04W 4/16; H04W 4/06; H04M 1/72563; H04W 88/06

(57) ABSTRACT

Methods, devices, and systems of various embodiments enable the handling of simultaneous calls on a MSMA device having at least a first subscriber identification module (SIM) associated with a first transceiver and a second SIM associated with a second transceiver. A processor may establish a first SIM call using the first transceiver. The processor may also establish a second SIM call using the second transceiver while maintaining the first SIM call active. The first SIM call may be maintained active by the processor connecting the first transceiver to a first input/output device and the second SIM call may be maintained active by the processor connecting the second transceiver to a second input/output device.

### RELATED APPLICATIONS

This application is related to U.S. patent application Ser. No. 14/330,806 entitled “Simultaneous Voice Calls Using a Multi-SIM Multi-Active Device” that is filed contemporaneously herewith and commonly assigned to Qualcomm Incorporated, the entire contents of which are hereby incorporated by reference for all purposes.

### BACKGROUND

Multi-SIM devices, such as cellular telephones, are devices that include more than one subscriber identification module (SIM). Multi-SIM devices have become increasing popular because of the versatility that they provide, particularly in countries where there are many service providers. For example, dual-SIM devices may allow a user to implement two different cellular service subscriptions or plans with different service providers, with separate numbers and bills, on the same device (e.g., business account and personal account). In addition, during travel, users can obtain local SIM cards and pay local call rates in the destination country. By using multiple SIMs, a user may take advantage of different service pricing plans and save on mobile data usage.

Multi-SIM multi-active (MSMA) devices have two or more SIMs using at least two separate radio resource chains. For example, a dual-SIM dual-active (DSDA) device can separately accommodate simultaneous wireless services. However, when both wireless services are voice calls, only one of those simultaneous voice calls may be active at a time because DSDA devices use one speaker and one microphone for conducting a voice call. Thus, the DSDA device places one voice call (i.e., the non-active voice call) in a hold state while the other voice call (i.e., the active call) uses the speaker and microphone. Other than merging the two calls into a conference call (which may be undesirable in most circumstances), a user has no way of talking/listening on two active voice calls at the same time.

### SUMMARY

Methods, devices, and systems of various embodiments enable the handling of simultaneous calls on a multi-SIM multi-active (MSMA) device having at least a first SIM associated with a first transceiver and a second SIM associated with a second transceiver. In various embodiments, a processor of the MSMA device may establish a first SIM call using the first transceiver and establish a second SIM call using the second transceiver while maintaining the first SIM call active. The processor may maintain the first SIM call active by connecting the first transceiver to a first input/output device (e.g., the microphone and speaker of the device) and maintain the second SIM call active by connecting the second transceiver to a second input/output device (e.g., a Bluetooth earpiece).

In some embodiments, the first input/output device may be the onboard input/output device of the MSMA device and the second input/output device may be a Bluetooth earpiece or another computing device coupled to the MSMA device by a Bluetooth wireless communication link. At least one of the first SIM call and the second SIM call may be an incoming call received by the MSMA device. At least one of the first SIM call and the second SIM call may be an outgoing call initiated from the MSMA device.

In some embodiments, a processor of the MSMA device may further receive the second SIM call while the first SIM call is maintained active. A user may be prompted regarding the received second SIM call, to which a user input may be received regarding simultaneously maintaining active the first SIM call and the second SIM call. In some embodiments, the second SIM call may be established using the second transceiver may be accomplished in response to a received user input electing to accept the second SIM call and maintain the first SIM call active. In some embodiments, a user input selecting an input/output device to use for the second SIM call may be received. Based on this user input, the second input/output device may be selected for the second SIM call. The first SIM call may be switched from using the second input/output device, if the second input/output device was being used for the first SIM call before the second SIM call was established. In some embodiments, the second SIM call may be initiated as an outgoing SIM call while the first SIM call is maintained active. In some embodiments, a look up of predefined user preferences of input/output devices may be performed in response to establishing the second SIM call. The second input/output device may be selected based on results of the look up of predefined user preferences.

In some embodiments, one of the first SIM call and the second SIM call may be selectively muted in response to user inputs. In some embodiments, the MSMA device may be a dual-SIM dual-active (DSDA) device.

Further embodiments include a method of performing the various operations discussed above, performed by the multi-antenna mobile device.

Further embodiments include a multi-antenna mobile device having means for performing functions corresponding to the various operations discussed above.

Further embodiments include a non-transitory processor-readable storage medium having stored thereon processor-executable instructions configured to cause a processor to perform functions corresponding to the various operations discussed above.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a communication system block diagram of a communication system according to various embodiments.

FIG. 2 is a component block diagram illustrating a MSMA device according to various embodiments.

FIG. 3 is a system architecture diagram illustrating example protocol layers of modem stacks implemented by a MSMA device according to various embodiments.

FIG. 4 is a communication flow diagram for various scenarios according to various embodiments.

FIG. 5 is a communication flow diagram for an additional scenario including selective muting according to various embodiments.

FIG. 6 is a process flow diagram illustrating a method of handling simultaneous calls on a MSMA device according to various embodiments.

FIG. 7 is a component diagram of an example MSMA device according to various embodiments.

FIG. 8 is a component diagram of an example MSMA device according to various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the invention or the claims.

Various embodiments enable two simultaneous voice calls to be maintained active on a MSMA device while keeping those voice calls separate. A first voice call using a first SIM (which is also referred to herein as a “first SIM call”) may be maintained using a first input/output device of the MSMA device (e.g., the handset speaker and microphone), while a second voice call using a second SIM (which is also referred to herein as a “second SIM call”) may be simultaneously maintained using a second input/output device coupled to the MSMA device (e.g., a remote input/output, such as a Bluetooth® headset).

The MSMA device may already have a first SIM call established and active in a conventional sense. The main user of the MSMA device may be given a choice about handling the two calls when receiving or initiating a second SIM call while the first call is active. The choice may allow the main user to direct the second SIM call to an input/output device not currently being used by the MSMA device. In some embodiments, the choice may allow the main user to switch the first SIM call to a different input/output device and receive the second SIM call on the input/output device previously used for the first voice call. In this way, the choice may allow the main user to direct each voice call selectively to a separate input/output device.

A single MSMA device may include two different ports that each may simultaneously transmit and receive the communications associated with an individual voice call. One port may feed audio signals to and receive audio signals from a first input/output device, such as an onboard input/output. A second port may feed audio signals to and receive audio signals from a second input/output device, such as a remote input/output device (e.g., a Bluetooth® headset or other paired remote input/output device). The onboard input/output may operate independently without interfering with the remote input/output device. In some embodiments, the MSMA device may allow the use of two separate remote input/output devices without using the onboard input/output device, to simultaneously maintain two active voice calls.

In some embodiments, a single user may simultaneously use the single MSMA device to conduct two separate voice calls, such as by listening to one call with the onboard speaker and listening to the other call with a remote speaker. For the single-user scenario, the MSMA device may offer additional enhancements, such as selective muting of one of the two microphones to prevent the user's voice from being transmitted by both voice calls.

The terms “mobile communication device” and “multi-SIM device” are used interchangeably herein to refer generally to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via at least one wireless communication pathway enabled by one or more SIMs.

The terms “multi-SIM multi-active device” and “MSMA device” are used interchangeably to refer to a mobile communication device with two or more SIMs and at least two radio resources configured for simultaneously maintaining at least two SIM communication sessions active. While various embodiments describe a DSDA device, which is a MSMA device having two SIMs and two separate radio resources, a MSMA device may have more than two SIM's. For example, a quad-SIM dual-active (QSDA) device includes four SIMs sharing two sets of radio resources. While a QSDA device may establish service with networks for as many as four SIMs, only two voice calls may be active at once. Other types of MSMA devices include a tri-SIM tri-active (TSTA) device or a quad-SIM quad-active (QSQA) device, which may include additional separate radio resources for each of the available SIMs.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service or services with a particular network, the term “SIM” is also used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM. For example, references to assigning a radio resource to a SIM (or granting a SIM radio access) means that the radio resource has been allocated to establishing or using a communication service with a particular network that is enabled by the information stored in that SIM.

As used herein, the terms “radio access network,” “wireless network,” and “cellular network” are used interchangeably to refer to a radio access network of one or more telecommunication carriers associated with a mobile communication device and/or subscription on a mobile communication device, and/or its roaming partners. A radio access network is generally a network that covers a broad area (i.e., any telecommunications network that links across metropolitan, regional, national or international boundaries).

As used herein, the terms “first SIM call,” “second SIM call,” “SIM call,” or “SIM calls” refer to voice calls from a mobile communication device using a SIM to communicate with a radio access network over a wide geographic region. Such telephone calls are “indirect” since they use a wireless access point to connect to the radio access network. For example, the radio access network may be a cellular network provided by a telecommunication carrier allowing access to public telephone networks from local base stations that serve as wireless access points.

As used herein, the term “direct communication link” is used to refer to a data communication connection between the MSMA device and a remote input/output device. The direct communication link may be a wired or a wireless data communication connection. A wired version of the direct communication link may use a wire or cable connecting an input/output port of the MSMA device with the remote input/output device. A wireless version of the direct communication link may use a relatively short-range wireless data communication connection directly between the MSMA device and the remote input/output device. Unlike a SIM call, a wireless version of the direct communication link does not include an intermediary wide area network (WAN) access point. For example, the direct communication link may use Bluetooth or Wi-Fi standards/protocols.

In a MSMA device, since each SIM may be associated with a separate radio resource (e.g., a DSDA communication device), the SIMs and their associated modem stacks may independently acquire and register for service with selected networks using the information stored in the respective SIMs. Depending on the particular communication protocols and/or radio access technologies of the selected networks, service acquisition and registration may include camping on a suitable cell of the network, and alerting the network of the presence in the serving cell. Successfully registering in a network, allows the modem stack corresponding to a SIM to operate in idle mode until a call is received or initiated. In an idle mode, the modem stack may perform functions such as monitoring a paging channel and performing cell reselection and location updates as needed.

When a network in which a SIM is registered receives a mobile terminating call, following authentication, a call setup may be sent to the MSMA device, which may respond to indicate whether the particular call type is enabled by the information stored in the SIM. If so, the processor may allocate the assigned traffic channel and the call is established. Once established, the processor manages data sent and received using the radio resource associated with that SIM, as well as onboard and/or remote resources.

In this manner, in a MSMA device, each radio resource associated with a SIM and its corresponding modem stack may operate as an independent device despite being co-located and sharing non-network based resources with one another (e.g., user input/output resources, processor and storage, etc.). Such independent functionality provides multiple user benefits, such as providing the user with essentially multiple different phones in the same physical housing. The various embodiments extend the benefits to include being able to conduct two voice calls at the same time.

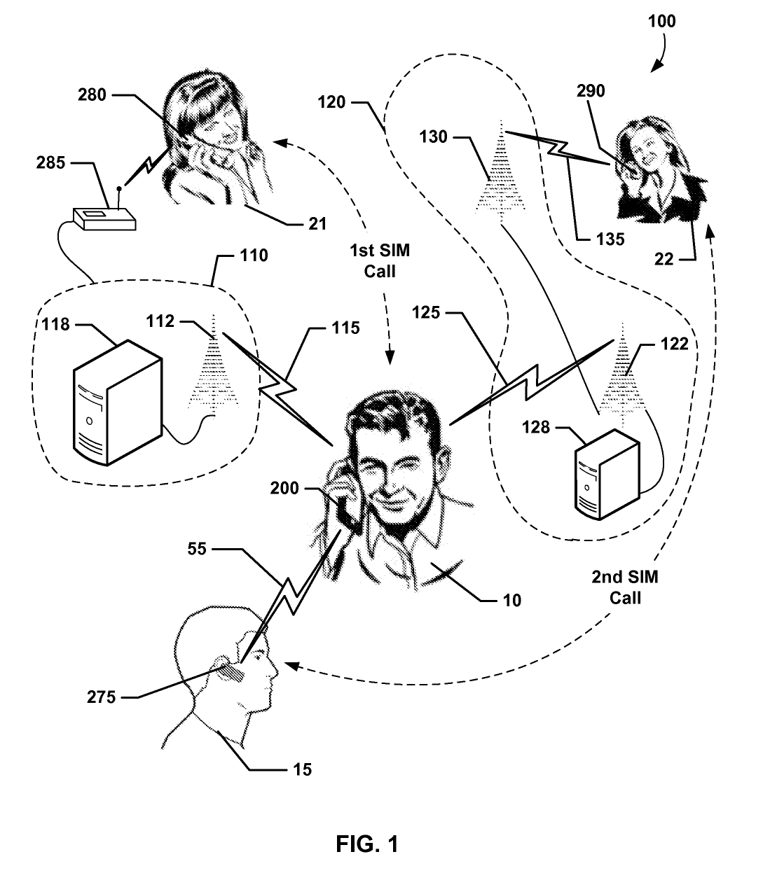

FIG. 1 illustrates a communication system 100 accessed by a mobile communication device, such as a MSMA device 200, handling simultaneous calls. The MSMA device 200 may have at least a first SIM associated with a first radio resource and a second SIM associated with a second radio resource. Each radio resource may include an antenna coupled to a receive and transmit radio coupled to a modem with communication stacks, encoders and decoders and related circuitry, which for ease of description are referred to herein as a “transceiver.” So configured, the MSMA device 200 may simultaneously establish and maintain wireless connections with more than one cell tower or base station of one or more radio access networks. A first SIM call (1^{St} SIM Call) may be established using the first SIM and a second SIM call (2^{nd} SIM Call) may be established using the second SIM. The first SIM call may be maintained active for a main user 10 listening to an onboard speaker and/or speaking into and onboard microphone of the MSMA device 200. Meanwhile, the second SIM call may be simultaneously maintained active using a remote input/output device 275, such as a wireless earpiece worn by a secondary user 15 using a direct communication link 55, such as a Bluetooth® connection.

The MSMA device 200 may establish and maintain the first SIM call using the first SIM to transmit/receive data through a first connection 115 to a first base station 112. The first base station 112 may be part of a first radio access network 110, which may be used to establish the first SIM call with a first third party 21. The first third party 21 may access the first radio access network 110 in various ways, such as through a fixed telephone line connection to the first radio access network 110. For example, the first third party 21 may use a short-range wireless handset 280 in conjunction with a personal base station 285 having a landline connection with access to the first radio access network 110. The main user 10 may communicate in this way with any third party with access to a radio access network.

In addition, the MSMA device 200 may simultaneously establish and/or maintain the second SIM call using the second SIM to transmit/receive data through a second connection 125 to a second base station 122. The second base station 122 may be part of a second radio access network 120, used to establish the second SIM call with a second third party 22. The second third party 22 may access the second radio access network 120 in various known ways, such as using a second mobile communication device 290 and its own wireless connection 135 to another base station 130 of the second radio access network 120.

The MSMA device 200 may use the direct communication link 55 in order to transfer the second SIM call through to the remote input/output device 275. In this way, the secondary user 15 may communicate with the second third party 22 on the second SIM call by way of the MSMA device 200. The remote input/output device 275 may be any type of electronic device that includes a microphone and/or speaker. For example, a laptop, desktop, or tablet computer, an iPod, an MP3 player, a headset or other audio input/output device. In various embodiments, audio signals may be transferred to the remote input/output device 275 via the direct communication link 55, which may be a wired or wireless connection.

The radio access networks 110, 120 may be cellular data networks, and may use channel access methods including, but not limited to, Global System for Mobile Communications (GSM), Universal Mobile Telecommunications Systems (UMTS) (particularly, Long Term Evolution (LTE)), Frequency Division Multiple Access (FDMA), Time Division Multiple Access (TDMA), Code Division Multiple Access (CDMA), Wi-Fi, PCS, 3G, 4G, or other protocols that may be used in a wireless communications network or a data communications network. The radio access networks 110, 120 may also be referred to by those of skill in the art as access networks, wireless networks, base station subsystems (BSSs), UMTS Terrestrial Radio Access Networks (UTRANs), etc. The radio access networks 110, 120 may use the same or different wireless interfaces and/or physical layers. In some embodiments, the base stations 112, 122 may be controlled by one or more base station controllers (BSC) 118, 128. Each radio access network 110, 120 may have additional base stations and/or BSC, as well as other components, as is known in the art. Alternate network configurations may also be used and the embodiments are not limited to the configuration illustrated. For example, in other embodiments, the functionality of the BSC 118 and at least one of base stations 112, 122, 130 may be collapsed into a single “hybrid” module having the functionality of these components.

In various embodiments, the MSMA device 200 may simultaneously access the radio access networks 110, 120 after camping on cells managed by one or more of the base stations 112, 122. Each of the radio access networks 110, 120 may provide various services to the MSMA device 200 via the respective first and second connections 115, 125. In various embodiments, radio access networks 110, 120 may each include a circuit-switched (CS) domain. Examples of circuit-switched entities that may be part of the radio access networks 110, 120 include a mobile switching center (MSC) and visitor location register (VLR), as well as Gateway MSCs GMSCs. The Radio access networks 110, 120 may be interconnected by connections from respective GMSCs to the public switched telephone network (PSTN), across which the radio access networks 110, 120 may route various incoming and outgoing communications to the MSMA device 200.

One or more of the radio access networks 110, 120 may also include a packet-switched (PS) domain. Example packet-switched elements that may be part of the radio access network 120 include a Serving GPRS Support Node (SGSN) and a Gateway GPRS Support Node (GGSN). The GGSN may connect to an IP network, across which the radio access network 110, 120 may route IP data traffic to and from the MSMA device 200. Other network entities (not shown) that may be part of the radio access networks 110, 120 may include an Equipment Identity Register (EIR), Home Location Register (HLR), and Authentication Center (AuC), some or all of which both the circuit-switched and packet-switched domains may share.

The MSMA device 200 may also establish connections to radio access networks via Wi-Fi access points, which may connect to the Internet. While various embodiments are particularly useful with radio access networks, the embodiments are not limited to wireless networks and may be implemented over wired networks with no changes to the methods.

The MSMA device 200 may be capable of operating with a number of radio access networks enabled by information stored in a plurality of SIMs. Using dual-SIM functionality, the MSMA device 200 may simultaneously access the two radio access networks 110, 120 by camping on cells managed by the base stations 112, 122. For example, the first SIM call may be a voice or data call to the first third party 21, such as to the wireless handset 280, using a service enabled by information stored in the first SIM, as well as the protocol stack associated with that SIM, via a first set of the radio resources, referred to herein collectively as a first transceiver. The MSMA device 200 may also simultaneously establish the second SIM call, which may be a voice call or data call to the second third party 22, in a similar manner using a service enabled by information stored in the second SIM, as well as the protocol stack associated with the second SIM, via a second radio resource, referred to herein collectively as a second transceiver. The communication devices used by the first third party 21 and/or the second third party 22 may be any communication device, including but not limited to a landline phone, mobile phone, laptop computer, PDA, server, etc.

The MSMA device 200 may include more than two SIMs (e.g., tri-SIM, quad-SIM, etc.). In this way, simultaneous calls may be established and maintained on more than two networks via the single MSMA device 200. A processor of the MSMA device 200 may use additional communication ports (other than a Bluetooth radio resource), such as Wi-Fi (not shown) or a wired connection, to connect a third call of a third SIM or a fourth call of a fourth SIM to additional remote speaker/microphone resources.

Some or all of the MSMA devices 200 may be configured with multi-mode capabilities and may include multiple transceivers for communicating with the different radio access networks 110, 120 over different wireless links/radio access technologies. For example, a MSMA device 200 that is a DSDA device may be configured to camp two SIMs on cells of two different networks though separate transmit/receive chains (i.e., independent radio resources) and communicate over the two networks on different subscriptions. For example, while the techniques and embodiments described herein relate to a MSMA device configured with at least one GSM subscription, they may be extended to subscriptions on other radio access networks (e.g., CDMA2000, UMTS, WCDMA, LTE, etc.).

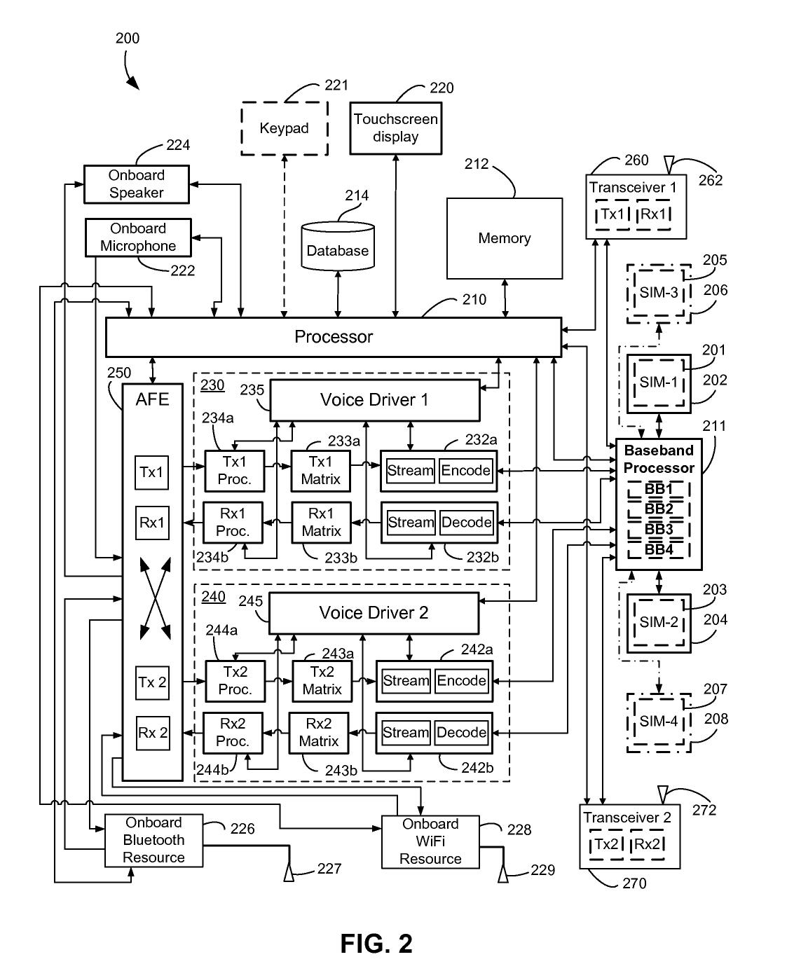

FIG. 2 illustrates a functional block diagram of an example of the MSMA device 200 that is suitable for implementing various embodiments. With reference to FIGS. 1-2, the MSMA device 200 may receive a first SIM 201, associated with a first subscription, through a first SIM interface 202. The MSMA device 200 may receive a second SIM 203, associated with a second subscription, through a second SIM interface 204. Optionally, the MSMA device 200 may include or be configured to receive more than two SIMs. For example, a tri-SIM embodiment may include a third SIM 205, associated with a third subscription, through a third SIM interface 206 and a quad-SIM embodiment may additionally include a fourth SIM 207, associated with a fourth subscription, through a fourth SIM interface 208.

Each of the SIMs 201, 203, 205, 207 used in various embodiments may contain user account information, an application toolkit, commands and storage space for phone book contacts and other information. The SIMs 201, 203, 205, 207 may further store home identifiers (e.g., a System Identification Number (SID)/Network Identification Number (NID) pair, a Home Public Land Mobile Network (HPLMN) code, etc.) to indicate the SIM network operator provider. An Integrated Circuit Card Identity (ICCID).

The MSMA device 200 may include at least one controller, such as a general-purpose processor 210, which may be coupled to a baseband modem processor 211 (or individual separate baseband modem processors BB1, BB2, BB3, BB4, if applicable). Each of the SIMs 201, 203, 205, 207 may be associated with a baseband-RF resource chain. Each baseband-RF resource chain may include or be coupled to the baseband modem processor 211 to perform baseband/modem functions for communications on a SIM, and one or more amplifiers and radios, referred to generally herein as access network transceivers 260, 270. In various embodiments, the baseband modem processor 211 may be common to all baseband-RF resource chains (i.e., a single device that performs baseband/modem functions for all SIMs on the wireless device). Alternatively, each baseband-RF resource chain may include physically or logically separate baseband modem processors (e.g., BB1, BB2, BB3, BB4).

The access network transceivers 260, 270 may each be communication circuits or transceivers that perform transmit/receive functions for the associated SIM of the wireless device. The access network transceivers 260, 270 may be communication circuits that include separate transmit and receive circuitry, or may include a transceiver that combines transmitter and receiver functions. The access network transceivers 260, 270 may be coupled to a wireless antenna (e.g., a first wireless antenna 262 and a second wireless antenna 272) for transmitting/receiving signals corresponding to wireless services associated with each SIM 201, 203, 205, 207 of the MSMA device 200. In addition, each access network transceiver 260, 270 may be coupled to separate wireless antennas 262, 272 for sending and receiving RF signals, providing separate transmit and receive functionality for the SIMs 201, 203, 205, 207. In this way, the MSMA device 200 may perform simultaneous communications with separate networks and/or service associated with the SIMs, or may include a transceiver that combines transmitter and receiver functions.

The access network transceivers 260, 270 may provide a network interface to the radio access networks by managing radio functions of one or more transceiver. The access network transceivers 260, 270 may include their own random-access memory (RAM) and firmware. The access network transceivers 260, 270 may also be coupled to the general-purpose processor 210 and the baseband modem processor 211. The separate access network transceivers 260, 270 and the wireless antennas 262, 272 may enable the MSMA device 200 to perform simultaneous communications with separate networks and/or service associated with the SIMs. With two access network transceivers 260, 270, the MSMA device 200 may function as a dual-active device (i.e., capable of communicating simultaneously with two different wireless access networks). Optionally, additional transceivers may be provided, along with corresponding additional SIMs (e.g., SIM-3 205 or SIM-4 207) in order to provide tri-active or quad-active capabilities. A tri-active device may maintain three simultaneous communications with three separate networks and/or service associated with at least three SIMs. A quad-active device may maintain four simultaneous communications with four separate networks and/or service associated with at least four SIMs.

The general-purpose processor 210 may be coupled to various on-board resources, including a touch screen display 220, which may output visual indications and service as an input device, such as providing a keypad or general user interface. Alternatively or in addition, the MSMA device 200 may include a separate keypad 221 coupled to the processor for receiving user input. In addition, the general-purpose processor 210 may be coupled to an onboard microphone 222 and an onboard speaker 224 for audio input and output, respectively. Together, the onboard microphone 222 and the onboard speaker 224 may also be referred to as the onboard input/output device 222/224 of the MSMA device 200. An onboard Bluetooth resource 226 may also be coupled to the general-purpose processor 210. The onboard Bluetooth resource 226 and onboard Bluetooth transceiver 227 may serve as a dedicated RF resource chain for Bluetooth communications with the paired remote input/output device 275 (e.g., a Bluetooth earpiece). An onboard Wi-Fi resource 228 may also be coupled to the general-purpose processor 210. The onboard Wi-Fi resource 228 and the onboard Wi-Fi transceiver 229 may serve as a dedicated RF resource chain for Wi-Fi communications with a connected remote input/output device. While Bluetooth and Wi-Fi connections are illustrated, additional communication resources and associated transceivers may be provided and used for remote connections to input/output devices.

An analog front-end (AFE) component 250 may be coupled to the general-purpose processor 210, as well as sensors and particularly select input/output devices (e.g., the onboard microphone 222, the onboard speaker 224, the onboard Bluetooth resource 226, and the onboard Wi-Fi resource 228). The AFE component 250 may be a set of analog signal conditioning circuitry that uses operational amplifiers, filters, and sometimes application-specific integrated circuits to provide a configurable and flexible analog to digital conversion for interfacing to components coupled thereto. The AFE component 250 may include a switch, or work with a separate switch component, in order to direct voice signaling between the appropriate input/output component and corresponding voice driver module 230, 240.

In various embodiments, the general-purpose processor 210 may control the AFE component 250 in order to direct signals received from the onboard microphone 222, the onboard Bluetooth resource 226, and/or the onboard Wi-Fi resource 228 to the appropriate access network transceiver 260, 270. Similarly, the general-purpose processor 210 may control the AFE component 250, in the other direction, in order to direct signals received from voice driver modules 230, 240 to the appropriate input/output component. In this way, voice call communications using a particular SIM 201, 203, 205, 207 may be associated with a select input/output device, such as the onboard input/output device 222/224, a device paired through Bluetooth® via the onboard Bluetooth resource 226, or a device connected through Wi-Fi via the onboard Wi-Fi resource 228. For example, in response to the main user 10 selecting to use the onboard input/output device 222/224 for a voice call using the first SIM (referred to as a “first SIM call”), the AFE component 250 may be configured to channel signals between the onboard input/output device 222/224 and the access network transceiver 260 associated with the first SIM 201. In addition, if the main user 10 decides to switch that first SIM call to the remote input/output device 275, via Bluetooth®, the general-purpose processor 210 may in-turn configure the AFE component 250 to switch internal connections/routing such that signals are channeled between the first transceiver 260 associated with the first SIM 201 and the onboard Bluetooth transceiver 227 via the onboard Bluetooth resource 226.

Each of the voice driver modules 230, 240 may be coupled to the general-purpose processor 210 through a respective voice driver 235, 245, which manages voice streams to correspond to devices used in conjunction with those voice streams. In addition, each of the voice driver modules 230, 240 may include a respective transmitting encoder 232a, 242a, which may be coupled to the corresponding voice driver 235, 245 and the baseband modem processor 211, and may perform stream processing and encoding/encrypting of data before signals are transmitted to the baseband modem processor 211 and the first and second transceivers 260, 270. Each of the transmitting encoders 232a, 242a may receive one or more signals from a respective transmitting audio matrix 233a, 243a, which processes received multichannel audio signals for later playback. Each of the transmitting audio matrix 233a, 243a may receive one or more signals from a respective transmitting pre-processor 234a, 244a, which receives the processed audio signals from the AFE component 250. The transmitting encoders 232a, 242a and transmitting pre-processors 234a, 244a may also be coupled to and controlled by the corresponding voice driver 235, 245. In this way, the transmitting pre-processor 234a, 244a, the transmitting audio matrix 233a, 243a, and the transmitting encoder 232a, 242a work together to process and transmit signals from the AFE component 250 to the baseband modem processor 211 and access network transceivers 260, 270.

For handling received audio signals, each of the voice driver modules 230, 240 may include a respective receiving decoder 232b, 242b, which may be coupled to the corresponding voice driver 235, 245 and the baseband modem processor 211, and may perform stream processing and decoding after signals are received from the access network transceiver 260, 270. Each of the receiving decoders 232b, 242b may forward one or more signals to a respective receiving audio matrix 233b, 243b that processes received multichannel audio signals for local playback. Each of the receiving audio matrix 233b, 243b may forward one or more signals to a respective receiving pre-processor 234b, 244b that directs the processed audio signals to the AFE component 250. The receiving pre-processor 234b, 244b may also be coupled to and controlled by corresponding the voice driver 235, 245. In this way, the receiving pre-processor 234b, 244b, the receiving audio matrix 233b, 243b, and the receiving decoder 232b, 242b work together to receive and process signals from the access network transceivers 260, 270, by way of the baseband modem processor 211, to the AFE component 250.

The general-purpose processor 210 may also be coupled to at least one memory 212. The memory 212 may be a non-transitory processor-readable storage medium that stores processor-executable instructions. For example, the memory may store processor-executable instructions for routing communication data relating to the first or second SIM subscriptions associated with a corresponding transceiver. The memory 212 may store operating system (OS) instructions, as well as user application software and executable instructions.

In various embodiments, the general-purpose processor 210, the baseband modem processor 211, the memory 212, the voice driver modules 230, 240, the AFE component 250, and/or the access network transceivers 260, 270 may be integrated on a system-on-chip device. In some embodiments, any one or more of the general-purpose processor 210, the baseband modem processor 211, the memory 212, the voice driver modules 230, 240, the AFE component 250, and/or the access network transceivers 260, 270 need not be integrated on the system-on-chip or may be integrated on a separate system-on-chip. The first, second, third, and fourth SIMs 201, 203, 205, 207 and their corresponding SIM interfaces 202, 204, 206, 208 may be external to the system-on-chip device. Further, various input and output devices may be coupled to components of the system-on-chip, such as interfaces or controllers. In addition, the general-purpose processor 210 may be coupled to additional resources, such as a database 214 for storing and accessing call information.

In various embodiments, the touch screen display 220, the keypad 221, the onboard microphone 222, the remote input/output device 275 (coupled through the onboard Bluetooth resource 226 and the onboard Bluetooth transceiver 227 or the onboard Wi-Fi resource 228 and the onboard Wi-Fi transceiver 229), or a combination thereof, may perform the function of receiving a request to initiate an outgoing call, accept and incoming call or even switch from using onboard resources to using remote resources. For example, the touch screen display 220 may receive a selection of a contact from a contact list or receive a telephone number for initiating a call. In another example, either or both of the touch screen display 220 and the onboard microphone 222 may perform the function of receiving a request to initiate an outgoing call or switch an active SIM call from using an onboard speaker/microphone to using a remote speaker/microphone or remote mobile communication device, or vise-versa. For example, the touch screen display 220 may receive a selection of a contact from a contact list, receive a telephone number for dialing, receive an indication whether to accept or decline an incoming call, or receive a user command to switch from using one pair to another. As another example, the request to initiate the outgoing call or switch resources may be in the form of a voice command received via the onboard microphone 222, the onboard Bluetooth resource 226, or the onboard Wi-Fi resource 228. Interfaces may be provided between various software modules and functions in MSMA device 200 to enable communication between them, as is known in the art.

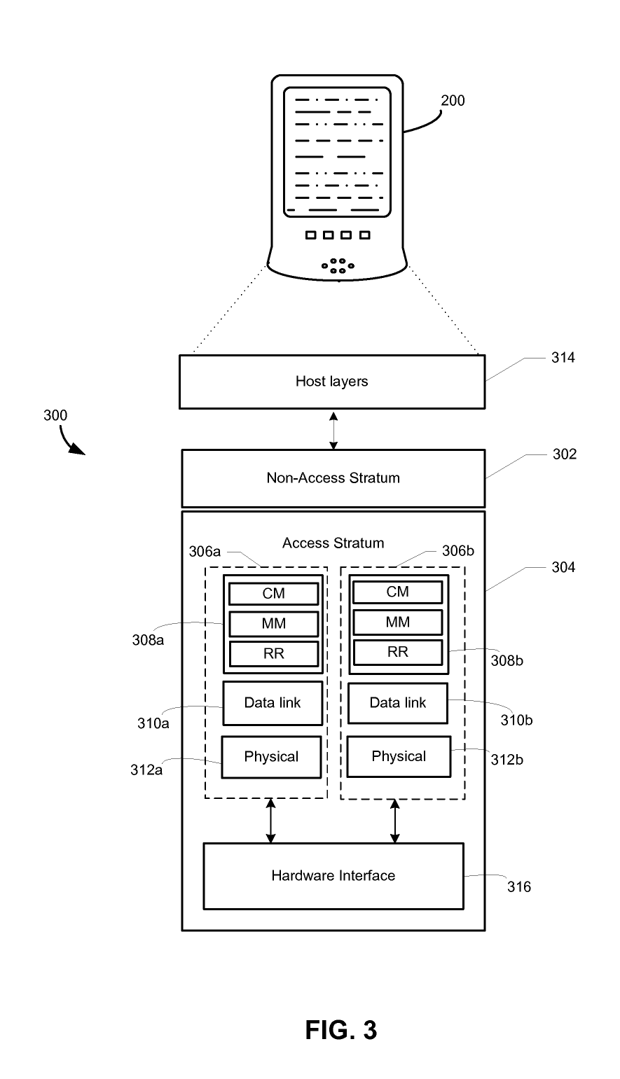

FIG. 3 illustrates a software architecture 300 of the MSMA device 200 for communicating with radio access networks associated with SIMs. With reference to FIGS. 1-3, the software architecture 300 may be distributed among one or more processors (e.g., the general-purpose processor 210 or voice drivers 235, 245). The software architecture 300 may also include a Non Access Stratum (NAS) 302 and an Access Stratum (AS) 304. The NAS 302 may include functions and protocols to support traffic and signaling between SIMs of the MSMA device 200 (e.g., the first SIM 201, the second SIM 203 of FIG. 2) and their respective radio access networks. The AS 304 may include functions and protocols that support communication between the SIMs and entities of their respective access networks (such as an MSC, if in a GSM network).

In the MSMA device 200, the AS 304 may include multiple protocol stacks, each of which may be associated with a different SIM. The protocol stacks may be implemented to allow modem operation using information provisioned on multiple SIMs. Therefore, a protocol stack that may be executed by a baseband modem processor is interchangeably referred to herein as a modem stack.

In some embodiments, the AS 304 may include protocol stacks 306a, 306b, associated with SIMs (e.g., the first SIM 201, the second SIM 203), respectively. Although described below with reference to GSM-type communication layers, protocol stacks 306a, 306b may support any of variety of standards and protocols for wireless communications. The protocol stacks 306a, 306b may respectively include the interface signaling layers 308a, 308b for mobile radio interface, which may each be implementations of Layer 3 of a GSM signaling protocol. Each of the signaling layer 308a, 308b may additionally include at least one sub-layer. For example, the connection management (CM) sub-layers may manage call control functions for circuit-switched communications in the network, such as establishing, maintaining and releasing call connections for communications. The CM sub-layer may also manage supplementary services and SMS communications.

Residing below the CM sub-layers in the signaling layers 308a, 308b, the mobility management (MM) sub-layers may support the mobility of user devices, and providing connection management services to the respective CM sub-layer functions arising from mobility of the user, as well as authentication and security. Example functions of the mobility management sub-layers may include provision of a MM connection, based on an existing radio resource connection, to the corresponding CM sub layer, location update procedures, and IMSI attach and detach procedures. Residing below the MM sub-layers, the radio resource management (RR) sub-layers may oversee the establishment of links between the MSMA device 200 and associated access networks, including management of the frequency spectrum, channel assignment and handover, power-level control, and signal measurements. In various embodiments, the NAS 302 and RR layers may perform the various functions to search for radio access networks and to establish, maintain and terminate calls.

Residing below the signaling layers 308a, 308b, the protocol stacks 306a, 306b may also include data link layers 310a, 310b, which may be part of Layer 2 in a GSM signaling protocol. The data link layers 310a, 310b may provide functions to handle incoming and outgoing data across the network, such as dividing output data into data frames and analyzing incoming data to ensure it has been successfully received. In some embodiments, each data link layer 310a, 310b may contain various sub-layers (e.g., media access control (MAC) and logical link control (LLC) layers (not shown)). Residing below the data link layers 310a, 310b, the protocol stacks 306a, 306b may also include physical layers 312a, 312b, which may establish connections over the air interface and manage network resources for the MSMA device 200.

While the protocol stacks 306a, 306b provide functions to transmit data through physical media, the software architecture 300 may further include at least one host layer 314 to provide data transfer services to various applications in the MSMA device 200. In some embodiments, application-specific functions provided by the at least one host layer 314 may provide an interface between the protocol stacks 306a, 306b and a processor (e.g., the general-purpose processor 210). In some embodiments, the protocol stacks 306a, 306b may each include one or more higher logical layers (e.g., transport, session, presentation, application, etc.) that provide host layer functions. In some embodiments, the software architecture 300 may further include in the AS 304 a hardware interface 316 between the physical layers 312a, 312b and the communication hardware (e.g., one or more RF transceivers).

Separate units of the baseband-modem processor 211 of the MSMA device 200 may be implemented as separate structures or as separate logical units within the same structure, and may be configured to execute software including at least two protocol/modem stacks associated with at least two SIMs, respectively. The SIMs and associated modem stacks may be configured to support a variety of communication services that fulfill different user requirements. Further, a particular SIM may be provisioned with information to execute different signaling procedures for accessing a domain of the radio access network associated with these services and for handling data thereof.

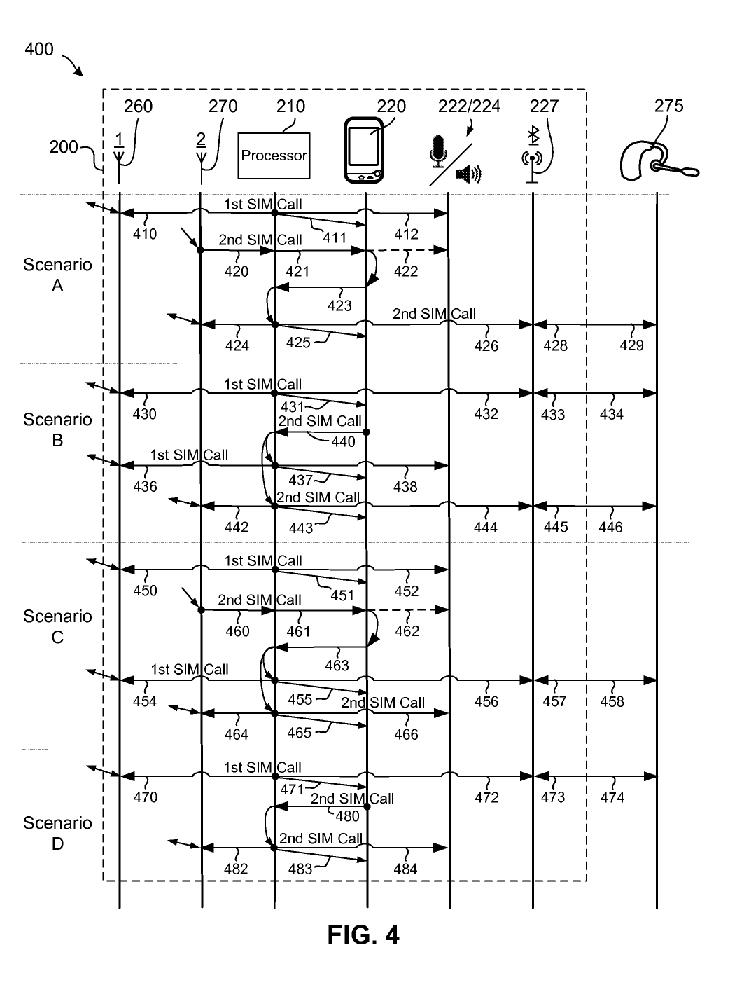

FIG. 4 illustrates communication flows 400 in four different scenarios of how simultaneous calls may be handled on an MSMA device (e.g., 200 in FIGS. 1-3) in accordance with various embodiments. The various scenarios refer to particular onboard resources of the MSMA device 200, as well as an exemplary remote input/output device (e.g., 275 in FIG. 1). With reference to FIGS. 1-4, the onboard resources include the general-purpose processor (processor) 210, the touch screen display 220, the onboard input/output device 222/224, the onboard Bluetooth transceiver 227, the first access network transceiver 260 (referred to as a “first transceiver 260”), and the second access network transceiver 270 (referred to as a “second transceiver 270”). The remote input/output device 275 may be a wireless earpiece configured to be paired with the MSMA device 200 and communicate via the onboard Bluetooth transceiver 227. References to voice calls, SIMs, radios, output devices, transceivers and antennas as “first” and “second” are merely for ease of the description. Thus, an established call may be referred to as the “first call” associated with a “first SIM” and a “first transceiver” that is output on a “first speaker” to distinguish that call from a subsequently connected voice call (“second call”) associated with a “second SIM” and a “second antenna” that is output on a “second speaker.” Calls may be established using services associated each SIM in any order, and therefore references to “first” and “second” are not intended to limit the scope of the claims to any order or particular association.

In various scenarios, a first SIM call is established before the second SIM call is established, and both SIM calls may be maintained active simultaneously. Either SIM may support the first established call, and either SIM may support the second call established, so the terms “first SIM call” and “second SIM call” refer only to the order in which the calls were established. The first SIM call may be associated with a first SIM of the MSMA device 200 and the second SIM call may be associated with a second SIM thereof.

The communication flows 400 are illustrated with four scenarios for call establishment that are possible when two calls are maintained active simultaneously. Scenario A illustrates call flows when the first voice call is being handled on the MSMA device's 200 onboard input/output device 222/224 when a second call is received and answered on the remote input/output device 275. Scenario B illustrates call flows when the first voice call is being handled on the remote input/output device 275 when the main user 10 decides to place a second call, and switches the first call to the onboard input/output device 222/224 in order to conduct the second call on the remote input/output device 275. Scenario C illustrates call flows when the first voice call is being handled on the onboard input/output device 222/224 when a second call is received and the main user 10 decides to switch the first call to the remote input/output device 275 so that the second call can be answered on the MSMA device's 200 onboard input/output device 222/224. Scenario D illustrates call flows when the first voice call is being handled on the remote input/output device 275 when the main user 10 decides to place a second call using the MSMA device's 200 onboard input/output device 222/224.

In the individual scenarios A-D, the call signaling and communication flows are referred to with different reference numbers as they are transmitted to or received from the remote input/output device 275, regardless of whether there are any substantial changes in the signaling or communication flows. In addition, in the individual scenarios different reference numerals indicate communication flows in opposite directions (i.e., one reference numeral for signals received from the access network and another reference numeral for signals transmitted to the access network).

Scenario A illustrates signal flows to establish two simultaneous SIM calls when the first SIM call is established using the onboard input/output device 222/224 and a received second SIM call is connected to the remote input/output device 275.

In Scenario A, the processor 210 has established the first SIM call and maintains the call active with a communication feed (i.e., a set connection) between the first transceiver 260 and the onboard input/output device 222/224. The first SIM call may originate from a remote caller (i.e., an incoming call) or from the MSMA device 200 (i.e., an outgoing call). Whether the first SIM call is an incoming call or an outgoing call, the first SIM call may be to a first radio access network (e.g., 110) using information stored in a first SIM 201 of the MSMA device 200. The onboard microphone 222 may capture and send transmission signals 410 to the first transceiver 260 for transmission to the first radio access network. In addition, received signals 412 from the first transceiver 260 are communicated to the onboard speaker 224 for output to the main user 10. The processor 210 may also transmit one or more first call updates 411 to the touch screen display 220 regarding the status of the call or other information associated with the first SIM call.

In Scenario A, the second transceiver 270 may receive an incoming call that will become a second SIM call, in which case the processor 210 receives a corresponding incoming call signal 420. The processor 210 in turn may provide an incoming call indication 421 to the touch screen display 220. Optionally, such as when the MSMA device 200 is set to provide audio alerts for incoming calls (i.e., the onboard speaker 224 is not in silence or vibration mode), the processor 210 may generate a ring-tone 422 associated with an incoming call for output by the onboard speaker 224. Generating the audible ring-tone 422 may be disruptive when the first SIM call is in progress and using the onboard input/output device 222/224, so in some embodiments a silent (i.e., visual and/or haptic) indication of the incoming call may be generated even when the device is not in silence mode.

The main user 10 interacting with the touch screen display 220 may accept the second SIM call by touching a displayed “Answer” icon (or the like) for example. In response to receiving an answer indication 423 from the touch screen display 220, the processor 210 may establish a communication feed for the second SIM call with its corresponding second network (e.g., 120) between the second transceiver 270 and the onboard Bluetooth transceiver 227. In this way, the processor 210 may ensure Bluetooth signals 428 received by the onboard Bluetooth transceiver 227 from the remote input/output device 275 transfer as transmission signals 424 to the second transceiver 270 for transmission to the second radio access network. In addition, received signals 426 from the second transceiver 270 may be transferred to the onboard Bluetooth transceiver 227 and conveyed as output signals 429 for output to the secondary user (e.g., 15) by the remote input/output device 275. The processor 210 may also transmit one or more second call updates 425 to the touch screen display 220 regarding the status of or other data associated with the second SIM call.

Scenario A illustrates how the second SIM call may be received and maintained active while also maintaining the first SIM call active. In response to receiving the second SIM call, the main user 10 was prompted for input and responded with an indication that both calls should be simultaneously maintained active. The first SIM call was active using the onboard input/output device 222/224, thus the second SIM call was established to actively use the remote input/output device 275.

Scenario B illustrates signal flows for simultaneous SIM calls handled by the MSMA device 200 in which the first SIM call is initially established using the remote input/output device 275. In response to initiating an outgoing second SIM call, the processor 210 switches the first SIM call to using the onboard input/output device 222/224 and the second SIM call is connected to the remote input/output device 275.

In Scenario B, the processor 210 has established the first SIM call and maintains the call active with a communication feed (i.e., connections) between the first transceiver 260 and the onboard Bluetooth transceiver 227 for output to the secondary user 15 by the remote input/output device 275. Once again, the first SIM call may originate from a remote caller (i.e., an incoming call) or from the MSMA device 200 (i.e., an outgoing call). Whether an incoming call or an outgoing call, the first SIM call may be associated with the first SIM (e.g., 201) and connects to a first radio access network (e.g., 110). Once the processor 210 establishes connections, the remote input/output device 275 may capture and send transmission signals 433 to the onboard Bluetooth transceiver 227, which in-turn transfers transmission signals 430 to the first transceiver 260 for transmission to the first radio access network. In addition, signals 432 received from the first transceiver 260 may be communicated to the remote input/output device 275 for output to the secondary user 15 by way of output signals 434 from the onboard Bluetooth transceiver 227. The processor 210 may also transmit one or more first call updates 431 to the touch screen display 220 regarding the status of or other data associated with the first SIM call.

Using the touch screen display 220 the main user 10 may initiate the second SIM call while the first SIM call is active. The second SIM call may use the second SIM (e.g., 203) of the MSMA device 200 to communication with the second radio access network (e.g., 120). The processor 210 may receive a call initiation signal 440 from the touch screen display 220, which may include a telephone number to call and other instructions. In addition to initiating the second SIM call, the call initiation signal 440 in Scenario B may also include instructions for switching the first SIM call from using the remote input/output device 275 to using the onboard input/output device 222/224 in conjunction with establishing the second SIM call. In this way, the second SIM call will be setup to use the remote input/output device 275 rather than the first SIM call.

In response to receiving the call initiation signal 440, the processor 210 may perform several operations, including switching resources in accordance with the call initiation signal 440 instructions. In particular, the processor 210 may establish internal connections (i.e., a communication feed) so that the onboard microphone 222 may capture and send transmission signals 436 to the first transceiver 260 for transmission to the first radio access network. In addition, internal call signals 438 received from the first transceiver 260 are communicated to the onboard speaker 224 for output to the main user 10. The processor 210 may also transmit one or more follow-up call updates 437 to the touch screen display 220 regarding the status of or other data associated with the first SIM call. The processor 210 may also establish a communication feed for a second SIM call. In this way, Bluetooth signals 445 received by the onboard Bluetooth transceiver 227 from the remote input/output device 275 may be transferred as transmission signals 442 to the second transceiver 270 for transmission to the second radio access network. In addition, internal redirected signals 444 received from the second transceiver 270 may be transferred to the onboard Bluetooth transceiver 227 and conveyed as output signals 446 for output to the secondary user 15 by the remote input/output device 275. The processor 210 may also transmit one or more second call updates 443 to the touch screen display 220 regarding the status of or other data associated with the second SIM call.

Scenario B illustrates how the second SIM call may be initiated and maintained active while also maintaining the first SIM call active along with switching the input/output devices. In other words, as part of initiating the second SIM call, input received from the main user (e.g., 10) may include a command for switching the first SIM call to using the onboard input/output device 222/224 in conjunction with establishing the first SIM call.

Scenario C illustrates signal flows for simultaneous SIM calls handled by the MSMA device 200 in which the first SIM call is initially established using the onboard input/output device 222/224, but in response to receiving an incoming second SIM call, the processor 210 switches the first SIM call to using the remote input/output device 275 so that the second SIM call is connected to the onboard input/output device 222/224.

In Scenario C, the processor 210 has established the first SIM call and maintains the call active with a communication feed (i.e., connections) established between the first transceiver 260 and the onboard input/output device 222/224. The first SIM call may originate from a remote caller or from the MSMA device 200. Whether an incoming call or an outgoing call, the first SIM call may be associated with the first SIM (e.g., 201) and may connect to the first radio access network (e.g., 110). Once the processor 210 establishes internal connections, the onboard microphone 222 may capture and send transmission signals 450 to the first transceiver 260 for transmission to the first radio access network. In addition, received signals 452 from the first transceiver 260 may be communicated to the onboard speaker 224 for output to the main user 10. The processor 210 may also transmit one or more first call updates 451 to the touch screen display 220 regarding the status of or other data associated with the first SIM call.

When the second transceiver 270 receives signals from its radio access network indicating that a second SIM call is incoming, the processor 210 receives a corresponding incoming call signal 460. In response, the processor 210 may provide an incoming call indication 461 to the touch screen display 220. Optionally, the processor 210 may also send a ring-tone 462 signal to the onboard speaker 224. As a further option, the incoming call indication 461 may provide selections for the main user 10 to make beyond accepting or declining the second SIM call. For example, the incoming call indication 461 may prompt the main user 10 regarding available remote input/output devices for use with either the established first SIM call or the received second SIM call. In particular, the main user 10 may notice from the prompt that a particular remote input/output device 275 is paired and available. In addition, the main user 10 may know that another individual (i.e., the secondary user 15) is currently wearing that remote input/output device 275. In this way, the main user 10 may decide to take the second SIM call locally, using the onboard input/output device 222/224, while transferring the first SIM call to the secondary user 15 using remote input/output device 275.

The incoming call indication 461 may include options to select and “Answer” icon or a “Decline icon, which either accepts or declines the call, respectively. The main user 10 interacting with the touch screen display 220 may accept the second SIM call by touching the displayed “Answer” icon. In response to the processor 210 receiving an answer indication 463 from the touch screen display 220, the processor 210 may establish the second SIM call. The answer indication 463 may include additional instructions, such as indications to switch microphone/speakers used for the calls.

In response to receiving the answer indication 463 associated with the incoming call indication 461 presented on the touch screen display 220, the processor 210 may perform several operations, including switching input/output devices associated with each call. In this way, the processor 210 may establish (i.e., set) internal connections so that Bluetooth signals 457 received by the onboard Bluetooth transceiver 227 from the remote input/output device 275 are transferred as transmission signals 454 to the first transceiver 260 for transmission to the first radio access network. In addition, received signals 456 from the first transceiver 260 may be transferred to the onboard Bluetooth transceiver 227. The onboard Bluetooth transceiver 227 may convey corresponding output signals 458 for output to a secondary user 15 by the remote input/output device 275. The processor 210 may also provide one or more follow-up call updates 455 to the touch screen display 220 regarding the status of or other data associated with the first SIM call.

In response to receiving the answer indication 463, the processor 210 may also establish internal connections so that the onboard microphone 222 may capture and send transmission signals 464 to the second transceiver 270 for transmission to the second radio access network. In addition, received signals 466 from the second transceiver 270 may be communicated to the onboard speaker 224 for output to the main user 10. The processor 210 may also provide one or more second call updates 465 to the touch screen display 220 regarding the status of or other data associated with the second SIM call.

Scenario C illustrates how a second SIM call may be received and maintained active using the onboard input/output device 222/224, while also maintaining the first SIM call active by switching the first SIM call to the remote input/output device 275.

Scenario D illustrates signal flows on the MSMA device 200, in which a first SIM call is initially established using the remote input/output device 275, and a received second SIM call is connected to the onboard input/output device 222/224.

In Scenario D, the processor 210 has established the first SIM call and maintains the first SIM call active with a communication feed between the first transceiver 260 and the onboard Bluetooth transceiver 227 for output to the secondary user (e.g., 15) by the remote input/output device 275. Once again, the first SIM call may originate as an incoming call or an outgoing call. Whether an incoming call or an outgoing call, the first SIM call is associated with the first SIM and connects to the first radio access network. Once the processor 210 establishes connections, the remote input/output device 275 may capture and send transmission signals 473 to the onboard Bluetooth transceiver 227, which transfers transmission signals 470 to the first transceiver 260 for transmission to the first radio access network. In addition, received signals 472 from the first transceiver 260 are communicated to the remote input/output device 275 for output to the secondary user 15 by way of output signals 474 from the onboard Bluetooth transceiver 227. The processor 210 may also transmit one or more first call updates 471 to the touch screen display 220 regarding the status of or other data associated with the first SIM call.

Using the touch screen display 220 the main user 10 may initiate an outgoing second SIM call, while the first SIM call is active. The second SIM call uses the second SIM of the MSMA device 200 to communication with the second radio access network (e.g., 120). The processor 210 may receives call initiation information 480 from the touch screen display 220, which may include a telephone number to call and other instructions. In response to receiving the call initiation information 480, the processor 210 may establish internal connections so that the onboard microphone 222 may capture and send transmission signals 482 to the second transceiver 270 for transmission to the second radio access network. In addition, received signals 484 from the second transceiver 270 are communicated to the onboard speaker 224 for output to the main user 10. The processor 210 may also transmit one or more second call updates 483 to the touch screen display 220 regarding the status of or other data associated with the second SIM call.

Scenario D illustrates how the main user 10 may initiate a second SIM call using the onboard input/output device 222/224 while the first SIM call is maintained active using the remote input/output device 275. For example, Scenario D may occur when a first SIM call has been established on the MSMA device 200, but another person (e.g., the secondary user 15) is wearing the remote input/output device 275 and handling the call. Although one SIM of the MSMA device 200 is busy with that first SIM call, the main user 10 may initiate a second SIM call using the second SIM and the onboard input/output device 222/224.

When receiving or initiating a second SIM call while a first SIM call is active, the main user 10 may be provided information regarding available onboard and/or remote input/output devices for use with either the first or the second SIM call. Optionally, the main user 10 may chose between multiple paired input/output devices, if more than one device is capable of simultaneously being paired using a direct communication link with the MSMA device 200.

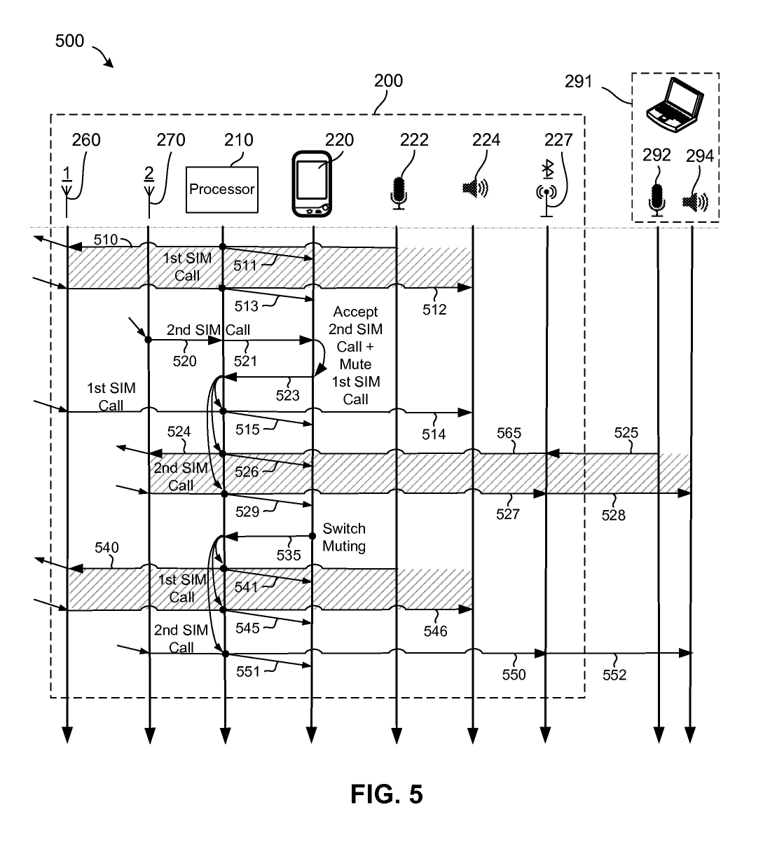

FIG. 5 illustrates a communication flow 500 corresponding to an additional scenario (Scenario E) of how simultaneous calls may be handled on the MSMA device 200 (FIGS. 1-4), in accordance with various embodiments. With reference to FIGS. 1-5, the communication flow 500 illustrates a selective muting feature that may be used in order to allow the main user 10 to simultaneously juggle two active voice calls.

In Scenario E, a remote input/output device 291, in the form of a laptop computer (or other suitable electronic device), is paired with the MSMA device 200 via the onboard Bluetooth transceiver 227. A remote microphone 292 and remote speaker 294 of the laptop computer 291 are illustrated separately in order to further explain differences between how incoming and outgoing signals may be handled. As above, the first SIM call may be associated with the first SIM of the MSMA device 200 and the second SIM call may be associated with the second SIM thereof.

In Scenario E, the processor 210 has established the first SIM call and maintains the call active with a communication feed (i.e., a set connection) between the first transceiver 260 and the onboard input/output device 222/224. Whether originating as an incoming call or an outgoing call, the first SIM call is associated with a first SIM and connects to a first radio access network (e.g., 110). Once the processor 210 establishes internal connections, the onboard microphone 222 may capture and send transmission signals 510 to the first transceiver 260 for transmission to the first radio access network. In addition, received signals 512 from the first transceiver 260 are communicated to the onboard speaker 224 for output to the main user 10. The processor 210 may also transmit first call reception updates 511 and first call transmission updates 513 to the touch screen display 220 regarding the status of incoming and outgoing data, or other data associated with the first SIM call.

When the second transceiver 270 receives signals from its radio access network (e.g., 120) indicating that a second SIM call is incoming, the processor 210 receives a corresponding incoming call signal 520. In response, the processor 210 may provide an incoming call indication 521 to the touch screen display 220. The main user 10, interacting with the touch screen display 220, may accept the second SIM call by touching a displayed “Answer” icon (or the like). In addition, the main user 10 may activate (or have already activated) a selective mute feature that selectively turns off one of the two input devices (i.e., microphones) used for the two calls. In this way, the main user 10 may accept and engage the selective mute feature in order to answer the second SIM call and greet the caller without being concerned the person involved in the first SIM call will hear the greeting.

The processor 210 may receive an answer indication 523 from the touch screen display 220 indicating the main user 10 is accepting the second SIM call and muting the first SIM call. In response to receiving the answer indication 523, the processor 210 may reconfigure the first SIM call to mute the onboard microphone 222 and establish the second SIM call. While the first SIM call is muted, the processor 210 may ensure the onboard microphone 222 input is not output, but received signals 514 from the first transceiver 260 may be communicated to the onboard speaker 224 for output to the main user 10. The processor 210 may also transmit additional first call reception updates 515 to the touch screen display 220 regarding the status of the first SIM call (e.g., active but muted) or other data associated with the first SIM call.

With the second SIM call established to use the remote microphone 292 and the remote speaker 294 of the laptop computer 291, the onboard Bluetooth transceiver 227 may receive Bluetooth signals 525 from the remote microphone 292 and relay the transmission signals 524 to the second transceiver 270. Internal redirect signals 527 received by the second transceiver 270 may be transferred to the onboard Bluetooth transceiver 227 to be transmitted as output signals 528 for output to the secondary user 15 by the remote speaker 294. The processor 210 may also transmit second call reception updates 526 and second call transmission updates 529 to the touch screen display 220 regarding the status of or other data associated with the second SIM call.

As part of the selective muting feature, the main user 10 may alternately mute and un-mute the first SIM call and the second SIM call in order to talk on each call without the person on the other call hearing him or her. A user input may be received by the processor 210 to switch muting from one call to the other as a switch muting indication 535. In response to receiving the switch muting indication 535, the processor 210 may reconfigure the first SIM call to un-mute the onboard microphone 222 and reconfigure the second SIM call to mute its remote microphone 292. To do so, the processor 210 may re-establish internal connections so that the onboard microphone 222 may capture and send transmission signals 540 to the first transceiver 260 for transmission to the first radio access network, and communicate signals 546 received from the first transceiver 260 to the onboard speaker 224 for output to the main user 10. In addition, the processor 210 may ensure signals 550 received from the second transceiver 270 are transferred to the onboard Bluetooth transceiver 227 to be conveyed as output signals 552 for output to the secondary user 15 by the remote speaker 294. The processor 210 may also transmit additional first call reception updates 541, second call reception updates 551, and first call transmission updates 545 to the touch screen display 220 regarding the status of incoming and outgoing data, or other data associated with the first and second SIM calls, such as an indication that the second SIM call is muted.

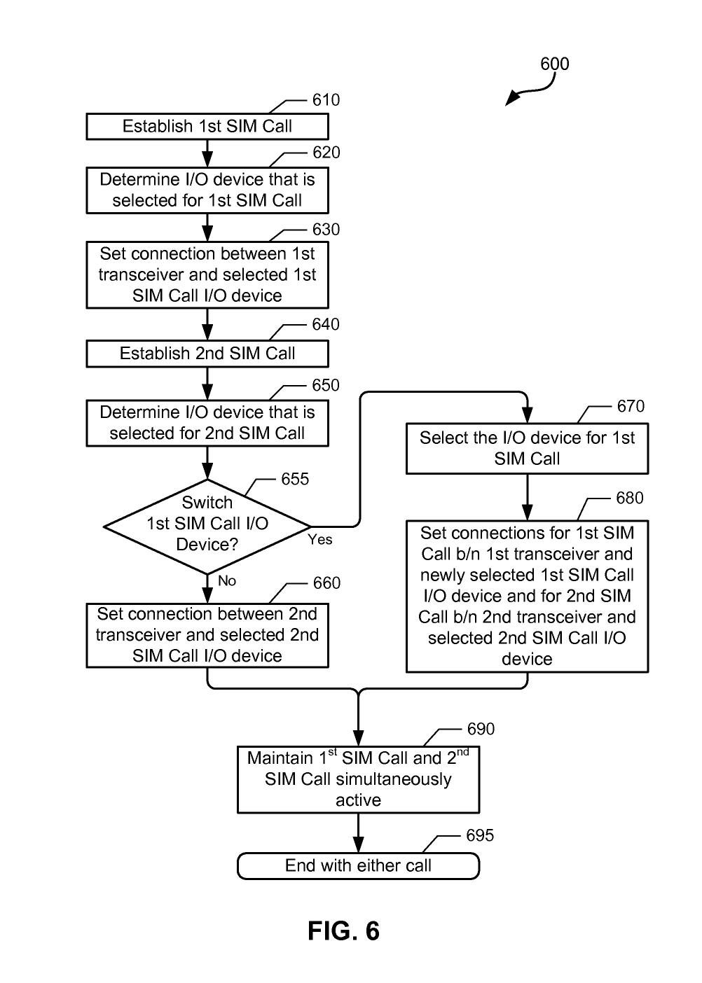

FIG. 6 illustrates a method 600 according to various embodiments for handling simultaneous calls on a MSMA device (e.g., 200 in FIGS. 1-5) having at least a first SIM associated with a first radio resource (e.g., first access network transceiver 260) and a second SIM associated with a second radio resource (e.g., second access network transceiver 270). With reference to FIGS. 1-6, the operations of method 600 may be implemented by one or more processors of the MSMA device, such as the general purpose processor (e.g., 210), the baseband modem processor (e.g., 211), or a separate controller (not shown) that may be coupled to the memory (e.g., 212), the voice driver modules (e.g., 230, 240), the AFE component (e.g., 250), and the access network transceivers (e.g., 260, 270).

In block 610, the processor of the MSMA device may establish a first SIM call. The first SIM call may be received from the first radio access network (e.g., 110) as an incoming call or be initiated from the MSMA device as an outgoing call. Whether an incoming call or an outgoing call, the first SIM call, which is associated with a first SIM, connects to a first radio access network with a first transceiver of the MSMA device. Establishing the first SIM call may include service acquisition, authentication, and/or registration with the first radio access network for sending and receiving data using the radio resources associated with the first SIM.

In block 620, the processor of the MSMA device may determine which input/output (i.e., I/O) device has been selected (such as by default, predefined settings, or by the user) for the input and output of the first SIM call. The input/output device may be an onboard input/output device or a remote input/output device. The selection of the input/output device for the first SIM call may be based on a user input. For example, the MSMA device may prompt the main user (e.g., 10) regarding available input/output devices and request a selection. The selection of the input/output device may be made based on a memory look-up of predefined user settings. For example, when no call is active, an incoming first SIM call may automatically be routed to the onboard input/output device when no remote input/output device is available.

In block 630, the processor of the MSMA device may set a connection between the first transceiver and the selected input/output device determined in block 620. For example, having determined that an onboard input/output device (e.g., 222/224) should be used for the first SIM call, the MSMA device processor may connect the first transceiver handling the call to the onboard microphone and the onboard speaker.

In block 640, the processor of the MSMA device may establish the second SIM call. The second SIM call may be received from a second radio access network (i.e., an incoming call) or be initiated from the MSMA device (i.e., an outgoing call). Whether an incoming call or an outgoing call, the second SIM call, which is associated with a second SIM, connects to a second radio access network with a second transceiver (e.g., 270) of the MSMA device. Establishing the second SIM call may include service acquisition, authentication, and/or registration with the second radio access network for sending and receiving data using the radio resources associated with the second SIM. When the second SIM call is initiated or received while the first SIM call is active, as part of establishing the second SIM call, the processor may prompt the user to decide whether to simultaneously maintain active two calls, as well as select an input/output device to use for the second SIM call.

In block 650, the processor of the MSMA device may select the input/output (i.e., I/O) device to use for the second SIM call. The input/output device may be the onboard input/output device or one or more remote input/output devices (e.g., a Bluetooth earpiece). The selection of the input/output device for the second SIM call may be based on a user selection, a default setting, and/or a predefined user setting. For example, as part of block 650, the main user may be prompted regarding available input/output devices and asked to make a selection. As part of selecting an input/output device, the main user may have the option to switch the input/output device of the first SIM call, such as in Scenario A. As another example, the operations of block 650 may include a memory look-up of predefined user settings to identify the input/output device to use under the current operational configuration. For example, if the first SIM call is using a wireless earpiece, the processor may connect the second SIM call using the onboard microphone and onboard speaker.

In determination block 655, the processor may determine whether the first SIM call needs to be switched to using a different input/output device. Such a switch may only be necessary if the first SIM call is using the input/output device selected for the second SIM call or the first SIM call needs to otherwise change input/output device in order to handle two simultaneous calls.

In response to determining that the first SIM call does not need to be switched from its currently selected input/output device (i.e., determination block 655=“No”), the processor may set a connection between the second transceiver and the selected second SIM call input/output device in block 660.

In response to determining that the first SIM call needs to be switched from its currently selected input/output device (i.e., determination block 655=“Yes”), the processor may select the input/output device for the first SIM call in block 670.

In block 680, the processor of the MSMA device may set connections for the first SIM call and the second SIM call, establishing the connections between the first transceiver and the newly selected input/output device determined in block 670, as well as the connection between the second transceiver and the selected second SIM call input/output device determined in block 650.

In block 690, the processor of the MSMA device may maintain the two calls simultaneously active, routing received signals to the corresponding onboard and/or remote input/output devices and relay transmission signals received from the corresponding input/output devices to the corresponding transceiver for transmission to respective wireless access networks. The first SIM call and the second SIM call may remain simultaneously active until one or both of the calls is terminated in block 695 (e.g., a connection is lost or one of the calling parties ends the call).

Optionally, if the MSMA device main user wants to handle both the first SIM call and the second SIM call, selective muting may be employed. For example, the first SIM call may be directed to the onboard input/output device 222/224, while the second SIM call is directed to the remote input/output device worn by that same main user. Using selective muting, the main user may ensure audio input to the MSMA device is only transmitted on one of the two calls at a time. In this way, in response to establishing the second SIM call while the first SIM call is active, outgoing communications of a first connection between the first transceiver and the first microphone may be muted. Meanwhile incoming communications of the first connection between the first transceiver and the first speaker are maintained active. Subsequently, the main user may activate a switch icon (or the like), providing user input for switching the mute feature to the other call. In this way, the processor of the MSMA device may receive a switch muting indication for un-muting the first SIM call or the second SIM call, and muting the other one of the first SIM call or second SIM call. The main user may provide the switch muting indication via user interface (e.g., 220), such as by pressing a physical button, an icon, or the like on a touchscreen display. In this way, when the main user wants to mute the first call and un-mute the second call, the user may press a button. In addition, releasing the button or icon when the user wants, may mute the second call and un-mute the first call.

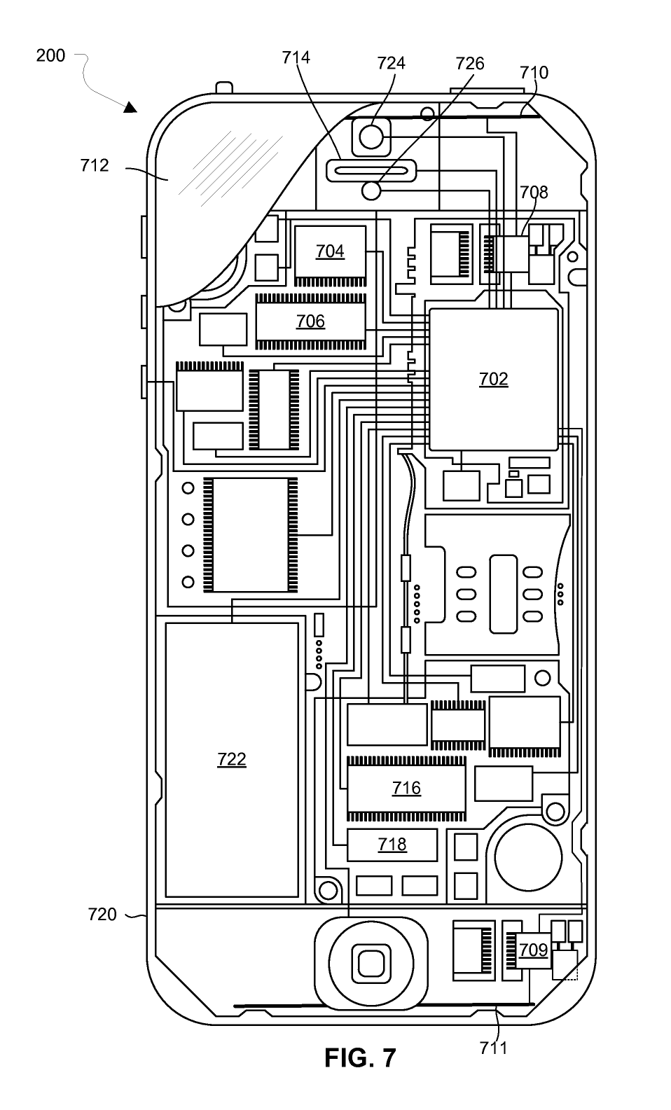

Various embodiments may be implemented in any of a variety of MSMA devices, an example of which is illustrated in FIG. 7. For example, the MSMA device 200 may include a processor 702 coupled to a touchscreen controller 704 and an internal memory 706. The processor 702 may be one or more multicore ICs designated for general or specific processing tasks. The internal memory 706 may be volatile or non-volatile memory, and may be secure and/or encrypted memory, or unsecure and/or unencrypted memory, or any combination thereof.

The touchscreen controller 704 and the processor 702 may also be coupled to a touchscreen panel 712, such as a resistive-sensing touchscreen, capacitive-sensing touchscreen, infrared sensing touchscreen, etc. The MSMA device 200 processor 702 may be coupled to two or more radio signal transceivers 708, 709 and antennas 710, 711 that enable communications via two or more cellular networks for sending and receiving voice and data calls. The transceivers 708, 709 and antennas 710, 711 may be used with the above-mentioned circuitry to implement the various wireless transmission modem stacks and interfaces.

The MSMA device 200 may include a peripheral device connection interface 718 coupled to the processor 702. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port (not shown). The MSMA device 200 may also include speakers 714 for providing audio outputs. The MSMA device 200 may also include a housing 720, constructed of a plastic, metal, or a combination of materials, for containing all or some of the components discussed herein. The MSMA device 200 may include a power source 722 coupled to the processor 702, such as a disposable or rechargeable battery. The rechargeable battery may also be coupled to the peripheral device connection port to receive a charging current from a source external to the MSMA device 200.

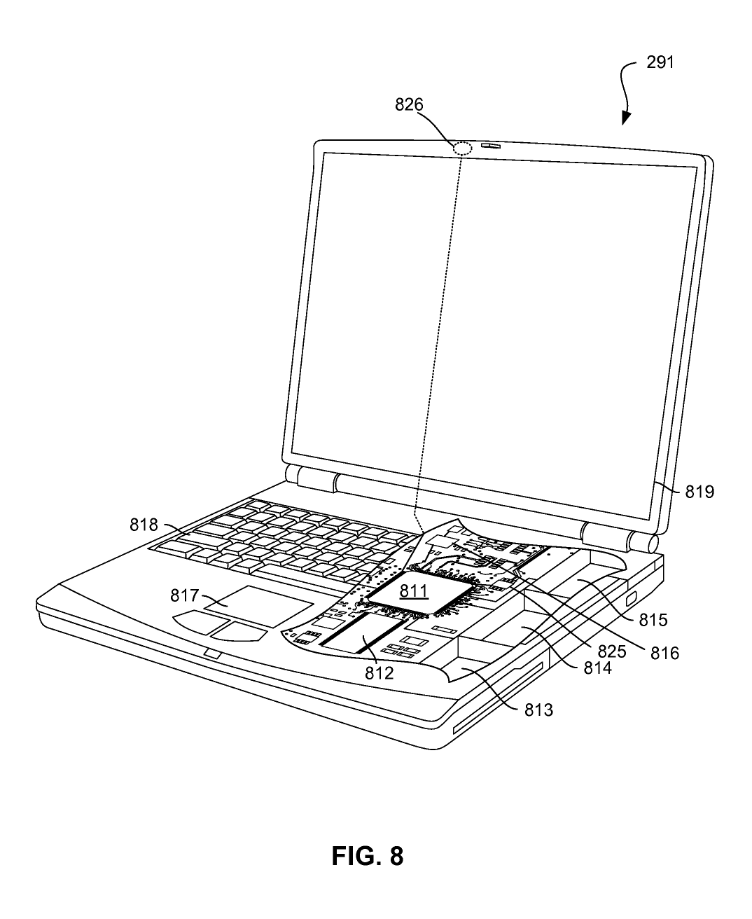

Various embodiments described above may also be implemented within a variety of personal computing devices, such as the laptop computer 291 as illustrated in FIG. 8. Such personal computing devices may service as the primary MSMA device (e.g., 200) described generally above or even the remote resource device (e.g., as described with regard to FIG. 5). The computer may include a touch pad touch surface 817 that serves as the computer's pointing device, and thus may receive drag, scroll, and flick gestures similar to those implemented on mobile communication devices equipped with a touch screen display as described. The laptop computer 291 may include a processor 811 coupled to volatile memory 812 and a large capacity nonvolatile memory, such as a disk drive 813 of Flash memory. The laptop computer 291 may also include a floppy disc drive 814 and a compact disc (CD) drive 815 coupled to the processor 811. The laptop computer 291 may also include a number of connector ports coupled to the processor 811 for establishing data connections or receiving external memory devices, such as a USB or FireWire® connector sockets, or other network connection circuits for coupling the processor 811 to a network. In a notebook configuration, the computer housing includes the touch pad touch surface 817, the keyboard 818, and the display 819 all coupled to the processor 811. Other configurations of the computing 291 may include a computer mouse or trackball coupled to the processor (e.g., via a USB input) as are well known, which may also be use in conjunction with various embodiments.

The processors 210, 211, 702, 811 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 212, 706, 812, 813 before they are accessed and loaded into the processors 210, 211, 702, 811. The processors 210, 211, 702, 811 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 210, 211, 702, 811 including internal memory or removable memory plugged into the MSMA device and memory within the processor 210, 211, 702, 811, themselves.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method of handling simultaneous calls on a multi-SIM multi-active (MSMA) device having at least a first subscriber identification module (SIM) associated with a first transceiver and a second SIM associated with a second transceiver, comprising:
establishing a first SIM call using the first transceiver;
establishing a second SIM call using the second transceiver while maintaining the first SIM call active;
maintaining the first SIM call active by connecting the first transceiver to a first input/output device; and
maintaining the second SIM call active by connecting the second transceiver to a second input/output device.

2. The method of claim 1, wherein the first input/output device is an onboard microphone/speaker of the MSMA device and the second input/output device is a remote device.

3. The method of claim 2, wherein the remote device is one of a headset and another computing device wirelessly coupled to the MSMA device.

4. The method of claim 1, wherein at least one of the first SIM call and the second SIM call is an incoming call received by the MSMA device.

5. The method of claim 1, wherein at least one of the first SIM call and the second SIM call is an outgoing call initiated from the MSMA device.

6. The method of claim 1, further comprising:
receiving the second SIM call while the first SIM call is maintained active;
prompting a user regarding the received second SIM call; and
receiving a user input regarding simultaneously maintaining active the first SIM call and the second SIM call,
wherein the second SIM call is established using the second transceiver in response to the received user input electing to accept the second SIM call and maintain the first SIM call active.

7. The method of claim 1, further comprising:
receiving a user input selecting an input/output device to use for the second SIM call;
selecting the second input/output device for the second SIM call based on the received user input; and
switching the first SIM call from using the second input/output device if the second input/output device was being used for the first SIM call before the second SIM call was established.

8. The method of claim 1, further comprising:
initiating the second SIM call as an outgoing SIM call while the first SIM call is maintained active.

9. The method of claim 1, further comprising
performing a look up of predefined user preferences of input/output devices in response to establishing the second SIM call; and
selecting the second input/output device based on results of the look up of predefined user preferences.

10. The method of claim 1, further comprising:
muting the first SIM call in coordination with establishing the second SIM call.

11. The method of claim 1, further comprising:
selectively muting one of the first SIM call and the second SIM call in response to user inputs.

12. The method of claim 1, wherein the MSMA device comprises a dual-SIM dual-active (DSDA) device.

13. A MSMA device, comprising:
a first transceiver;
a second transceiver; and
a processor coupled to the first transceiver, the second transceiver, and configured to be coupled to a first subscriber identification module (SIM), and a second SIM, wherein the processor is configured with processor-executable instructions to perform operations comprising:
establishing a first SIM call using the first transceiver;
establishing a second SIM call using the second transceiver while maintaining the first SIM call active;
maintaining the first SIM call active by connecting the first transceiver to a first input/output device; and
maintaining the second SIM call active by connecting the second transceiver to a second input/output device.

14. The MSMA device of claim 13, wherein the first input/output device is an onboard microphone/speaker of the MSMA device and the second input/output device is a remote device.

15. The MSMA device of claim 14, wherein the remote device is one of a Bluetooth earpiece and another computing device coupled to the MSMA device by a Bluetooth wireless communication link.

16. The MSMA device of claim 13, wherein at least one of the first SIM call and the second SIM call is an incoming call received by the MSMA device.

17. The MSMA device of claim 13, wherein at least one of the first SIM call and the second SIM call is an outgoing call initiated from the MSMA device.

18. The MSMA device of claim 13, wherein the processor is configured with processor executable instructions to perform operations further comprising:
receiving the second SIM call while the first SIM call is maintained active;
prompting a user regarding the received second SIM call; and
receiving a user input regarding simultaneously maintaining active the first SIM call and the second SIM call,
wherein the second SIM call is established using the second transceiver in response to the received user input electing to accept the second SIM call and maintain the first SIM call active.

19. The MSMA device of claim 13, wherein the processor is configured with processor executable instructions to perform operations further comprising:
receiving a user input selecting an input/output device to use for the second SIM call;
selecting the second input/output device for the second SIM call based on the user input; and
switching the first SIM call from using the second input/output device if the second input/output device was being used for the first SIM call before the second SIM call was established.

20. The MSMA device of claim 13, wherein the processor is configured with processor executable instructions to perform operations further comprising:
initiating the second SIM call as an outgoing SIM call while the first SIM call is maintained active.

21. The MSMA device of claim 13, wherein the processor is configured with processor executable instructions to perform operations further comprising:
performing a look up of predefined user preferences of input/output devices in response to establishing the second SIM call; and
selecting the second input/output device based on results of the look up of predefined user preferences.

22. The MSMA device of claim 13, wherein the processor is configured with processor executable instructions to perform operations further comprising:
muting the first SIM call in coordination with establishing the second SIM call.

23. The MSMA device of claim 13, wherein the processor is configured with processor executable instructions to perform operations further comprising:
selectively muting one of the first SIM call and the second SIM call in response to user inputs.

24. The MSMA device of claim 13, wherein the MSMA device comprises a dual-SIM dual-active (DSDA) device.

25. A MSMA device, comprising:
means for establishing a first SIM call using a first transceiver of the MSMA device;
means for establishing a second SIM call using a second transceiver of the MSMA device while maintaining the first SIM call active;
means for maintaining the first SIM call active by connecting the first transceiver to a first input/output device; and
means for maintaining the second SIM call active by connecting the second transceiver to a second input/output device.

26. A non-transitory processor-readable storage medium having stored thereon processor-executable instructions configured to cause a processor to perform operations for handling simultaneous calls on a MSMA device having at least a first subscriber identification module (SIM) associated with a first transceiver and a second SIM associated with a second transceiver, the operations comprising:
establishing a first SIM call using the first transceiver;
establishing a second SIM call using the second transceiver while maintaining the first SIM call active;
maintaining the first SIM call active by connecting the first transceiver to a first input/output device; and
maintaining the second SIM call active by connecting the second transceiver to a second input/output device.
